(19) United States
(12) Patent Application Publication
(10) Pub. No.: US 2025/0044071 A1
(43) Pub. Date: Feb. 6, 2025

(54) SMART SHELF LOCATION DETECTION SYSTEM

(71) Applicant: Walmart Apollo, LLC, Bentonville, AR (US)

(72) Inventor: David Balaun, Noel, MO (US)

(21) Appl. No.: 18/793,840

(22) Filed: Aug. 4, 2024

Related U.S. Application Data
(60) Provisional application No. 63/517,837, filed on Aug. 4, 2023.

(51) Int. Cl. G01B 7/06; A47B 57/34; A47F 10/00; G09F 3/20

(52) U.S. Cl. CPC G01B 7/082; A47B 57/34; A47F 10/00; G09F 3/208

(57) ABSTRACT

Examples provide a shelf location detection system. A shelf is supported by a shelf support arm engaging a notch in a smart shelf support member having a stack of resistors in series within the interior of the shelf support member. A plug on the support arm removably couples to the notch. A sensor detects a change in voltage across at least one resistor in the resistor stack. A location of the shelf on the smart shelf support member is determined using the detected voltage change. A controller on the smart shelf support member transmits the location to a controller on each accessory device on the shelf. The shelf can further include a plurality of resistors connected in series. The accessory device detects changes in voltage through the plurality of resistors and generates an estimated position of the accessory device on the shelf using the change in voltage data.

### BACKGROUND

Various types of technological devices are frequently used in retail environments to enable customers and staff to obtain desired information, as well as navigate the retail environment more easily. These accessory devices can include, for example, a camera, digital display, electronic shelf label (ESL), near field communications (NFC) device, or other internet of things (IoT) devices, which are frequently placed on or near shelves displaying products. These accessory devices typically require up-to-date location information providing the device with a flexible understanding of its position in the environment. This can necessitate installation of such devices by specially trained technicians and/or manually programming these devices with location information. In such cases, the accessory devices cannot be easily moved to a new location. Moreover, the presence of these device on a shelf can hinder or prohibit operations, such as replacing shelving, reconfiguring modulars, replacing broken displays, installing sensor devices, etc. This is a time-consuming process that adds to the cost and complexity of the system, while reducing convenience for end-users.

### SUMMARY

Some examples provide a shelf location detection system having a set of shelf support members with a plurality of notches. The set of shelf support members includes a smart shelf support member having a plurality of resistors connected in series situated within an interior of the shelf support member. A voltage changes as current flows through the plurality of resistors. A shelf is removably attached to the set of shelf support members by a set of support arms. The first support arm in the set of support arms includes a mounting bracket configured to removably couple to a shelf support notch in the plurality of notches on the smart shelf support member. A connector is coupled to the mounting bracket of the support arm. The connector is configured to engage a contact surface associated with the shelf support notch. A sensor associated with the shelf detects the change in voltage across the plurality of resistors when the mounting bracket of the support arm engages the contact surface. A controller device of the shelf includes a processor and a memory. The controller device generates location data based on the detected change in the voltage across the plurality of the resistors. The location data includes an estimated height of the shelf. An accessory device connected to the shelf self-configures, at least in part, using the location data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a shelf location detection system including a series of serial data ports.

FIG. 2 is an exemplary block diagram illustrating a shelf location detection system including a plurality of slots associated with a plurality of serial data ports in a vertical shelf support member.

FIG. 3 is an exemplary block diagram illustrating a shelf location detection system including a support arm having a plug for engaging a serial data port in a shelf support member.

FIG. 4 is an exemplary block diagram illustrating a shelf location detection system including a resistor stack within a vertical shelf support member.

FIG. 5 is an exemplary block diagram illustrating a shelf having a stack of resistors in parallel for improved location detection of devices on the shelf.

FIG. 6 is an exemplary illustration of a set of shelves having smart shelf height detection.

FIG. 7 is an exemplary illustration of a set of shelves having a controller box associated with the set of shelves.

FIG. 8 is an exemplary illustration of a cross-section view of a vertical shelf support member and a shelf support arm.

FIG. 9 is an exemplary illustration of a partially exploded view of a vertical shelf support member having a series of serial ports within an interior of the vertical shelf support member.

FIG. 10 is an exemplary illustration of a plug on a shelf support arm for connecting to the vertical shelf support member.

FIG. 11 is an exemplary illustration of a side view of a plug for a shelf support arm.

FIG. 12 is an exemplary illustration of a top view of a plug for a shelf support arm.

FIG. 13 is an exemplary flow chart illustrating operation of the controller device on the shelf to provide location data to accessory devices for self-configuration.

FIG. 14 is an exemplary flow chart illustrating operation of the controller device of the shelf to provide an estimated height of the shelf above ground to accessory devices for self-configuration.

FIG. 15 is an exemplary block diagram illustrating a system for detecting the location of a shelf.

FIG. 16 is an exemplary block diagram illustrating a cross-section view of a smart shelf support member having a plurality of resistors embedded within the smart shelf support member.

FIG. 17 is an exemplary block diagram illustrating a cross-section view of a smart shelf having a plurality of resistors embedded within the smart shelf support member.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

It is frequently desirable to include electrically powered peripheral devices on or near shelving, such as, but not limited to, digital signage, shelf cameras, lighting, and electronic shelf labels, and other devices. An electronic shelf label can also be referred to as a digital shelf label, a digital tag, or an electronic tag.

As more Internet of things (IoT) and other electronic devices become introduced to store shelves, more time and technical expertise is required to set-up and configure these devices. For example, when setting up a camera, it is sometimes necessary to program in a location of the camera such that the images captured by the camera are linked to the location within the store where the images were captured. Likewise, electronic shelf labels typically display information associated with products on the shelf where the electronic shelf label is located. Therefore, it is frequently necessary for the electronic shelf label to be paired with a specific item or shelf location so that correct item information is displayed on the electronic shelf label. Configuring these devices with the correct location information manually can be a time-consuming process which becomes more burdensome as the number of electronic devices increases. This further inhibits the user's ability to reconfigure shelving, re-arrange accessory devices on shelving and change modular designs, as every alteration in shelving or accessory device location necessitates re-configuration of the accessory device.

Referring to the figures, examples of the disclosure enable shelf location detection. In some examples, a shelf support member includes a controller and serial data ports. The controller stores location data describing the location of each notch on the shelf support member. When a shelf is removably attached to one of the notches, the controller transmits location data identifying the shelf support member and identifying the notch to which the shelf is attached. The location data is provided to the shelf and any accessory devices attached to the shelf for greater precision in locating shelves and devices on shelves.

In other examples, the system provides location data to shelves and/or accessory devices to enable the accessory devices mounted on a shelf to self-configure or partially self-configure. This reduces device configuration time while enabling greater flexibility for placement and modification of shelves and accessory devices within a retail environment.

Other aspects further enable a smart shelf support member having a stack of resistors in series and a voltage running down the shelf support member through the resistors. A sensor on each shelf is able to detect changes in the voltage across the resistors. The voltage change is used by a controller on each shelf to calculate an estimated height of each shelf above a base level, such as a floor or the ground. The shelf provides the estimated height to accessory devices. The accessory devices are able to self-configure in whole or in part using the estimated height calculated based on the voltage change through the resistor stack. This further improves ease of device configuration, reduces costs, improves scalability, and reduces set-up time when modular displays are created or modified.

Still other examples provide a smart shelf having a resistor stack of resistors in series located inside the shelf near the edge of the shelf where one or more accessory devices attach to the shelf. The accessory device includes a sensor which measures the voltage change as a current flows through the resistors in series. A controller on the accessory device generates an estimated location of the accessory on the edge of the smart shelf based on the change in voltage. This enables a location detection manager on an accessory device to determine an estimated position of the accessory device on a shelf as well as obtain the location of the shelf on the modular display. This enables improved accuracy of location data for greater ease of device configuration and reduced error during device setup and/or updates. The location detection manager further enables increased scalability and adaptability of modular locations, designs, product placement and configurability of both shelving as well as accessory devices.

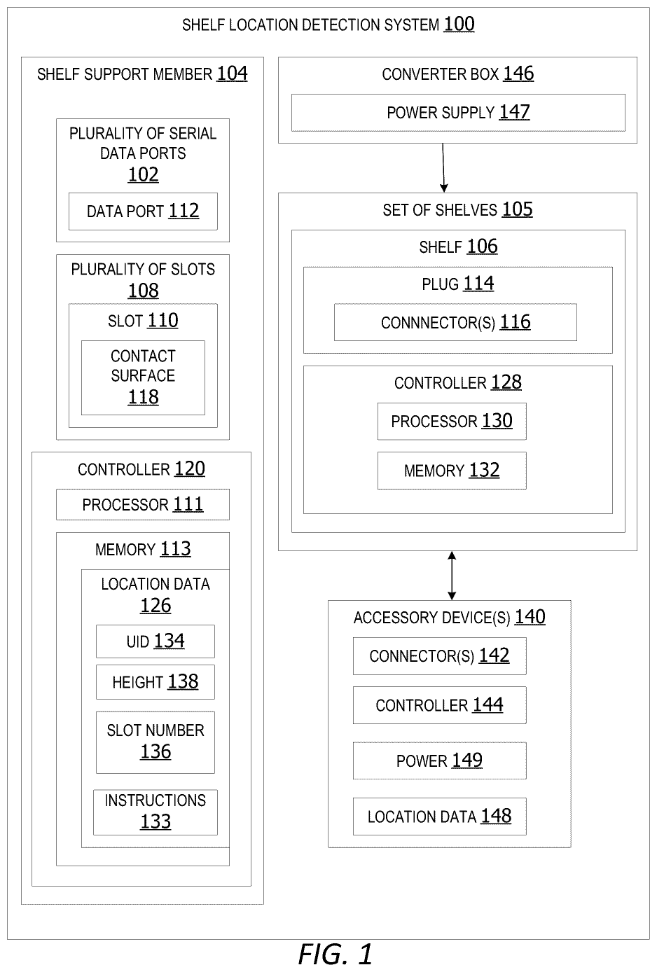

Referring to FIG. 1, an exemplary block diagram illustrating a shelf location detection system 100 including a plurality of serial data ports 102 is shown. In some examples, a shelf support member 104 is configured to support one or more removable shelves, such as, but not limited to, a set of shelves 105. A shelf support member is a device for mounting a shelf or a portion of a shelf to a fixture, such as, but not limited to, a wall, a post or other fixture. A shelf support member can be implemented as a rail, pipe, rectangular support frame, or any other device for supporting at least one side of a shelf via a shelf support arm.

In some non-limiting examples, the set of shelf support members are mounted vertically to a wall in a parallel configuration with each other. In these examples, the vertical support members are mounted a distance apart that is equal to the width of one or more shelves to be mounted on the vertical support rails. However, the examples are not limited to vertical support members. In other examples, the shelf support member(s) are mounted horizontally to a fixture for mounting one or more shelves to the shelf support member.

The shelf support members may be composed of metal, plastic, a composite material, or any other suitable material. In one example, the set of shelf support members are implemented as a pair of vertical shelf support rails made of a metal, such as aluminum, steel, or other suitable material.

In this example, the shelf support member 104 is a vertical shelf support member mounted to a base member or a fixture, such as a wall. However, the examples are not limited to vertical support members. In other examples, the shelf support member 104 can include a horizontal support member, a floating shelf support member, or any other type of support member onto which a shelf support arm removably attaches. In other examples, the shelf support member 104 is attached to a base member which supports the shelf support member 104 in an upright and vertical orientation.

Each shelf 106 in the set of shelves 105 is removably attached to the vertical shelf support member 104 via one or more slots in a plurality of slots 108 along the vertical shelf support member 104. In other words, the housing of the shelf support member includes a plurality of notches in a front face of the shelf support member. A notch in the plurality of notches is a mounting slot which enables a mounting plug to couple to the shelf support member. In some examples, the notches are arranged equidistance apart in a row along the length of the front face.

A notch, in some examples, is a substantially oval shaped slot or aperture on one of the faces of the shelf support member. However, the examples are not limited to an oval shaped notch. In other examples, the notches may be round, square, horizontal, triangular-shaped, or any other shape sized to enable a portion of the mounting plug to fit within the notch during mounting of the shelf.

Each notch in the shelf support member 104 is associated with a data port 112 in the plurality of serial data ports 102 within an interior area inside the shelf support member 104. In these examples, the shelf support member 104 is hollow or partially hollow having the series of plurality of serial data ports 102 at least partially disposed within the interior of the shelf support member 104.

The shelf 106 is removably mounted onto the shelf support member 104 by inserting a plug 114 mounted on a support arm of the shelf 106 into one or more of the slots in the plurality of slots 108. One or more connector(s) 116 associated with the plug 114 engages a contact surface 118 of the slot 110 to receive power and/or data via the plug 114. In some non-limiting examples, the plug 114 includes a serial data port, such as, but not limited to, a universal serial bus (USB) data port. The connector(s) 116, in other examples, include one or more prongs. In some examples, a connector on a plug includes two prongs. In other examples, the plug includes three prongs in which one of the three prongs is a ground. The prongs can also be referred to as pins or tabs.

A controller 120 of the shelf support member 104 includes a processor 111 and a memory 113. The memory 113 stores location data 126 for the location of the shelf support member 104 within an environment, such as, but not limited to, a retail environment. The processor 111 transmits data, including the location data 126, to a controller 128 on the shelf 106 via the data port 112 associated with the slot 110 to which the plug 114 of the shelf 106 is connected.

The processor 111 includes any quantity of processing units and is programmed to execute the computer-executable instructions 133. The computer-executable instructions 133 is executed by the processor 111, performed by multiple processors within the controller 120 or performed by a processor external to the controller 120. In some examples, the processor 111 is programmed to execute instructions such as instructions to transmit stored location data to a shelf controller and/or an accessory device on the shelf.

The memory 113 includes any quantity of media associated with or accessible by the controller 120. The memory 113, in these examples, is internal to the controller 120 (as shown in FIG. 1). In other examples, the memory 113 is external to the controller (not shown). The memory 113 can include read-only memory. The memory 113 stores data, such as the instructions 133.

The controller 128 is a controller on one or more of the shelves in the set of shelves 105, such as, but not limited to, the shelf 106. The controller 128 includes a processor 130 and a memory 132. The controller is a device, such as, but not limited to, the controller 120. The controller 128 receives the location data 126 pushed to the shelf 106 by the controller 120 on the shelf support member 104. However, the examples are not limited to data pushed to the shelf by the controller 120 on the shelf support member. In other examples, the controller 128 on the shelf requests the location data or a location update from the controller 120.

The processor 130 is a processing device, such as, but not limited to, the processor 111. The processor 130 includes one or more processors. The memory 113 is a memory device, such as, but not limited to, the memory 113.

In some examples, the controller 128 receives the location data 126 from the shelf support member 104. The location data 126 includes a universal identifier (UID) 134, a slot number 136 and/or a height 138 of the shelf 106 above a fixed surface, such as a floor, the ground or other base level. The UID 134 is an identifier associated with the shelf support member 104. Each shelf support member within a given area or location is assigned a unique identifier. The UID for a first vertical shelf support member is a different UID than the UID assigned to a second vertical shelf support member.

The slot number 136 is a unique number or other identifier assigned to each slot in the plurality of slots 108. In one example, if the slot 110 is the 20th slot down from the top, the slot number is twenty (20). In other examples, the slots in the plurality of slots are assigned any type of unique identifier, such as, but not limited to, an alphanumeric, ordinal number, cardinal number, letter, etc. The slot number 136 assigned to a first slot is a different number than the slot number assigned to a second slot. The shelf stores the location data for the shelf on the memory 132 of the controller 128 on the shelf 106. The location data 126 provides data describing the location of the shelf on the vertical shelf support member relative to the slot(s) and/or the ground.

When one or more accessory device(s) 140 are connected to the shelf 106, the controller 128 of the shelf 106 transmits the location data 126 to each of the accessory device(s) 140. An accessory device is any type of device which can be removably attached to a shelf. In some examples, an accessory device receives power and/or data from the shelf. An accessory device can include, for example, an electronic shelf label (digital tag), light, sensor device, camera, speaker, display screen, etc.

Each accessory device connects to the shelf 106 via one or more connector(s) 142 on the accessory device(s). The connector(s) 142, in this example, is a data port, such as a USB port that plugs into a corresponding port on the shelf. The accessory device receives power 149 and the location data 148 of the shelf via the connector(s) 142. In some examples, a controller 144 on the accessory device(s) 140 is able to self-configure using the location data 148 received from the shelf controller 128. Each time a new accessory device is connected to the shelf via a data port, the shelf controller sends the most up-to-date location data 126 to the accessory device.

The accessory device self-configures using the location device in some examples. Self-configuration refers to the process of configuring the IoT or other accessory device using the location data without human intervention or with minimal human intervention. For example, if the accessory device is an image capture device associated with the shelf, such as a camera, the image capture is able to determine its location and/or the location of the shelf using the location data. The image capture device self-configuration may include generating a name for the image capture device based on the location, adding metadata to generated images which includes an identification of the location or inclusion of the location data, etc.

In other examples, if the accessory device is an electronic shelf label, the accessory device self-configuration can include identifying items displayed on the shelf based on the location of the electronic shelf label and/or determining which item information to display on the electronic shelf label based on the location data. The item information displayed by an electronic shelf label can include pricing information, size, brand, count, variety, sale information, etc.

In some examples, if the shelf 106 is detached from the vertical shelf support member at a first slot and re-attached to the shelf support member 104 at a different, second slot at a higher or lower level along the vertical shelf support member, the vertical shelf support member controller 120 sends updated location data 126 including a new slot number 136 to the shelf 106. The shelf controller 128 updates the location data in the memory 132 with the new updated location data. The updated location data is then sent to any accessory devices which are attached to the shelf 106.

A converter box 146 is a power converter (transformer) that converts electrical power at a first voltage down to a lower, second voltage. For example, the converter box 146 can step down 220V to 12V. In another example, the converter box 146 can change 120V electricity to 12V. In some examples, the converter box 146 is located at the top of a set of shelves and/or attached to the highest shelf in the set of shelves 105. The converter box 146 provides a power supply 147 to the shelf support member 104 and/or the set of shelves 105. In some examples, the power flows from the vertical support member to the set of shelves via the plurality of serial data ports 102. The power supply can include power received from an electrical utility, power from a generator, power from one or more solar panels, power received from one or more batteries, or any other power source. The set of shelves 105 provides power to the accessory device(s) connected to the set of shelves.

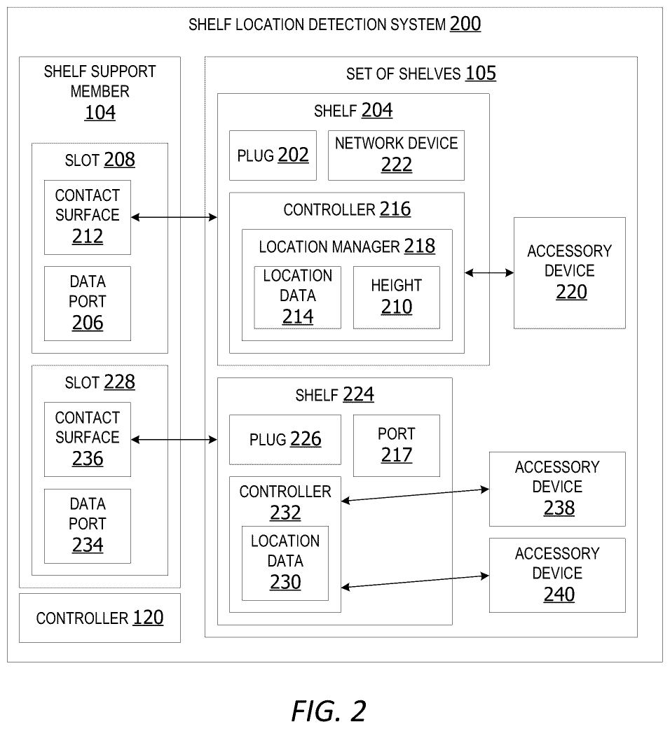

FIG. 2 is an exemplary block diagram illustrating a shelf location detection system 200 including a plurality of slots associated with a plurality of serial data ports in a vertical shelf support member 104. The system 200 is a system for smart shelves capable of detecting the location of the shelf on a shelf support member, such as, but not limited to, the shelf location detection system 100 in FIG. 1.

In some examples, a plug 202 associated with a first shelf 204 connects to a data port 206 associated with a slot 208. The slot 208 is located at a given height 210 above a surface, such as the ground, floor, or other base. The height 210 is the distance or approximate distance above the surface.

When the plug 202 engages a contact surface 212 within the slot 208, the controller 120 of the shelf support member 104 transmits the location data 214 describing the location of the shelf 204 relative to the shelf support member 104 via the data port 206. A controller 216 on the shelf 204 includes a processor and memory executing a location manager 218. The location manager 218 includes hardware, firmware, and/or software configured to store the location data 214 and transmits the location data to an accessory device 220 when the accessory device 220 is initially connected to the shelf 204.

In some examples, the shelf 204 controller 216 sends the location data to the accessory device via a wired connection, such as a USB port or other physical plug which connects the accessory device to a port 217 on the shelf 204. In other examples, the shelf controller 216 transmits the location data 214 wirelessly to the accessory device 220 via a network device 222.

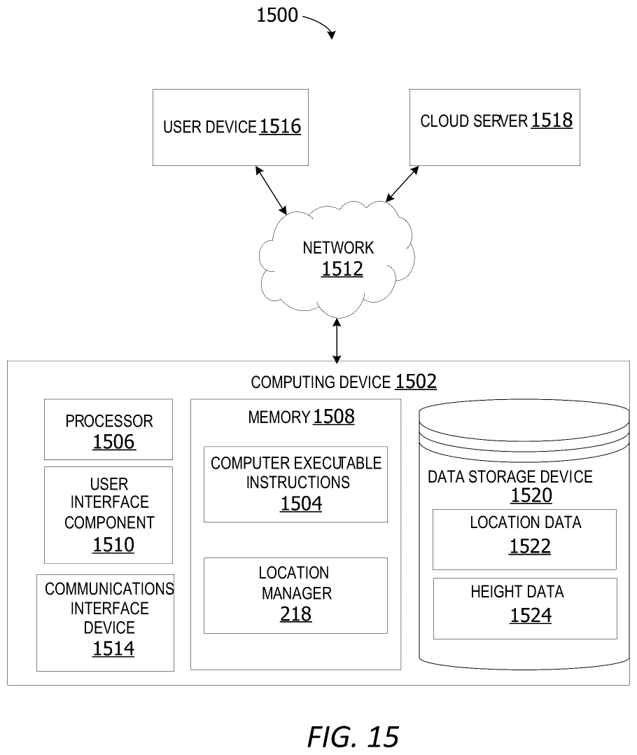

The network device 222 creates a wired or wireless network connection between the shelf and the accessory device 220. The network device is implemented as one or more physical network components, such as, but without limitation, routers, switches, network interface cards (NICs), and other network devices. The network is any type of network for enabling communications with remote computing devices, such as, but not limited to, a local area network (LAN), a subnet, a wide area network (WAN), a wireless (Wi-Fi) network, or any other type of network, such as, but not limited to, the network 1512 in FIG. 15.

Communication between the shelf controller 216 and other devices, such as but not limited to, the accessory device 220, can occur using any protocol or mechanism over any wired or wireless connection. In some examples, the network device 222 is operable with short range communication technologies such as by using near-field communication (NFC) tags. In this example, the network device 222 is an NFC or Bluetooth device enabling the controller 216 to transmit the location data to the accessory device 220 wirelessly.

A second shelf 224 includes a plug 226 which connects to a slot 228 in the shelf support member 104. The shelf support member controller transmits location data 230 to a controller 232 of the shelf 224 via a data port 234 when the plug 226 engages the contact surface 236 of the slot 228. The plug 226 engages the contact surface when the plug is inserted into the slot 228. The location data 230 includes different location data than location data 214. For example, although the location data 230 and the location data 214 both contain the same shelf support member UID identifying the same vertical shelf support member 104, the location data 214 includes a different slot number and/or different height above the floor than the location data 230. For example, shelf 204 may be located at slot number 12 while shelf 224 is located at slot number 32.

The controller 232 transmits the location data 230 to any accessory device connected to the shelf via a wired or wireless connection, such as, but not limited to, the accessory device 238 and/or accessory device 240. In these examples, the controller pushes the location data to every accessory device connected to the shelf via a wired or wireless connection. In other examples, the accessory device can request the location data from the shelf during an initialization phase when the accessory device is initially connected to the shelf. Communications may occur between the shelf controller and an accessory device via any known or available communications protocol. The connection is established using any known connection protocol, such as, but not limited to, Wi-Fi IoT protocol, Bluetooth, Zigbee, etc.

In this example, the shelf 224 includes two accessory devices. However, in other examples, any number of accessory devices may be connected to the shelf 224. For example, the shelf 224 can support a single accessory device, as well as three or more accessory devices. Moreover, a shelf may include no accessory devices. In such cases, the controller stores the location data until an accessory device is detected on the shelf. An accessory device is detected when the accessory device is connected to the shelf to receive power and/or data from the shelf.

In some examples, the set of shelves 105 is a set of one or more shelves in a display, such as a modular display within a store or other retail space. The set of shelves in one example includes one or more open shelves or shelves in a display. In other examples, the set of shelves include one or more shelves within a refrigerated display case, one or more shelves within a freezer display, one or more shelves within a deli display case, one or more shelves on an end-cap display, one or more shelves on a rotating display, one or more shelves within an enclosed glass display case, or any other type of shelving unit having at least at least one mounting plug associated with at least one shelf engaging a power bus.

The set of shelves 105 includes two or more shelves in this example, shelf 204 and shelf 224. However, the examples are not limited to a set of shelves having two shelves. In other examples, the set of shelves can include a single shelf, as well as three or more shelves. In still other examples, the shelf support member 104 may currently have no shelves physically connected to it. In such cases, the controller of the shelf support member waits until a shelf is connected to one of the data ports to begin transmitting location data to the shelf. The accessory device 220 uses the location data 214 to determine the location of the accessory device. The accessory device 220, in some examples, is able to self-configure using the location data 214.

In this example, the system 200 is depicted as a separate system from the system 100 as shown in FIG. 1. However, in other examples, the system 200 incorporates one or more of the elements from FIG. 1. For example, the system 200 can optionally include one or more of the contact surface 118, the accessory device(s) 140, the converter box 146, etc.

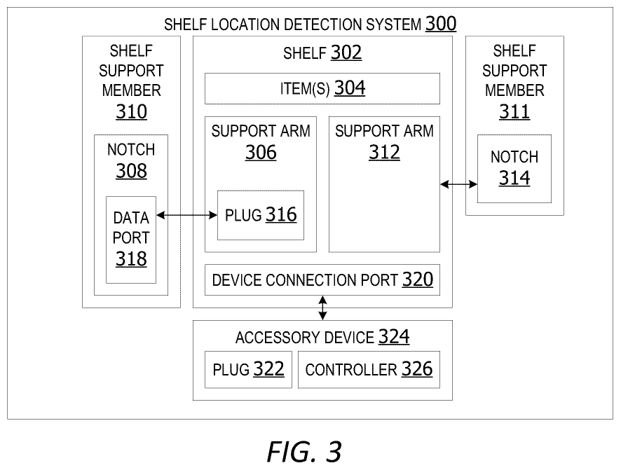

Turning now to FIG. 3, an exemplary block diagram illustrating a shelf location detection system 300 including a support arm having a plug for engaging a serial data port in a shelf support member is shown. The system 300 is a system providing a smart shelf capable of detecting a location of the shelf, such as, but not limited to, the system 100 in FIG. 1 and/or the system 200 in FIG. 2.

A shelf 302 is a smart shelf for displaying one or more item(s) 304. The shelf 302 is a shelf having a controller for sending and receiving location data, such as, but not limited to, the shelf 106 in FIG. 1 and/or the shelf 204 and/or 224 in FIG. 2. The shelf includes a pair of shelf support arms for removably attaching to a pair of shelf support members. In this example, a first support arm 306 removably connects to a notch 308 in a first vertical shelf support member 310. The shelf support arm 306 is an arm for removably connecting to a vertical shelf member and supporting at least a portion of a shelf.

A second support arm 312 removably connects to a second notch 314 in a second vertical shelf support member 311. The notch 308 and the notch 314 are substantially parallel. A plug 316 associated with the support arm 306 engages a data port 318 to obtain location data from a controller of the shelf support member 310. In this example, the second support arm 312 does not include a plug, as only one plug on one support arm is sufficient to obtain location data for the shelf.

In some examples, each shelf includes one or more plug(s) at one end of one or more shelf support arms. In an example, a mounting plug is provided at an end of one support arm on one side of each shelf.

In other examples, the plug is mounted to a bracket member for removably attaching the support arm to at least a portion of the shelf support member. The mounting plug also includes a plug having a tab for engaging a power bus within the shelf support arm to receive electrical power at the second, stepped-down voltage.

An accessory device 324 optionally includes a plug 322 for connecting to a device connection port 320 on the shelf. The accessory device runs on electricity and is located on or otherwise attached to the shelf. The accessory device 324 can be implemented as any type of accessory device for use on or in association with a shelf, such as, for example, a shelf light, an electronic shelf display, a camera, a motion detector, a coupon dispenser, or any other device. An electronic shelf display is a display screen, electronic shelf label, electronic tag, shelf edge display or other display.

The electronic shelf display can include text, graphics, audio, and/or video information output to a user. An electronic shelf display can provide promotional information, discount information, product labeling information, videos, or other output displayed to the user.

The shelf controller transmits the location data to the accessory device via the plug 322. The controller 326 of the accessory device 324 stores the location data on the accessory device and uses the location data to self-configure or partially self-configure the accessory device 324 without human intervention.

In this example, the system 300 is depicted as a separate system from the system 100 as shown in FIG. 1 and the system 200 shown in FIG. 2. However, in other examples, the system 300 incorporates one or more of the elements from FIG. 1 and/or FIG. 2 in combination with the elements shown in FIG. 3. For example, the system 200 can optionally include one or more of the contact surface 118, the network device 222, the converter box 146, etc.

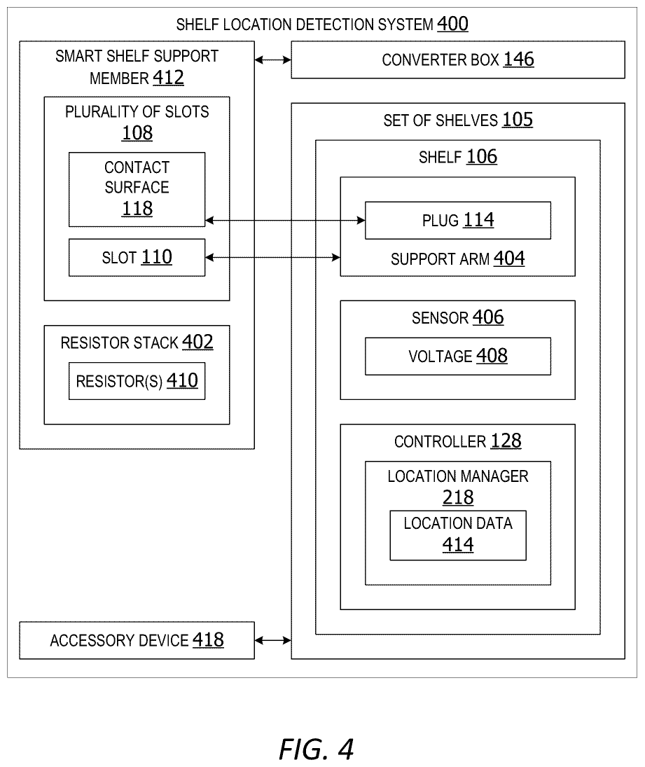

FIG. 4 is an exemplary block diagram illustrating a shelf location detection system 400 including a resistor stack 402 within a vertical shelf support member. The system 400 is a system for enabling a shelf to detect its own height above a surface, such as a floor, the ground, or a base member on a set of shelves 105 using a stack of resistors in series, such as, but not limited to, the resistor stack 402.

The resistor stack 402 is a set of two or more resistors connected together in a serial manner. The resistors in the resistor stack 402 are not connected in parallel. Therefore, a voltage moving through the resistors in the resistor stack 402 changes as the voltage moves down (across) the resistor stack 402.

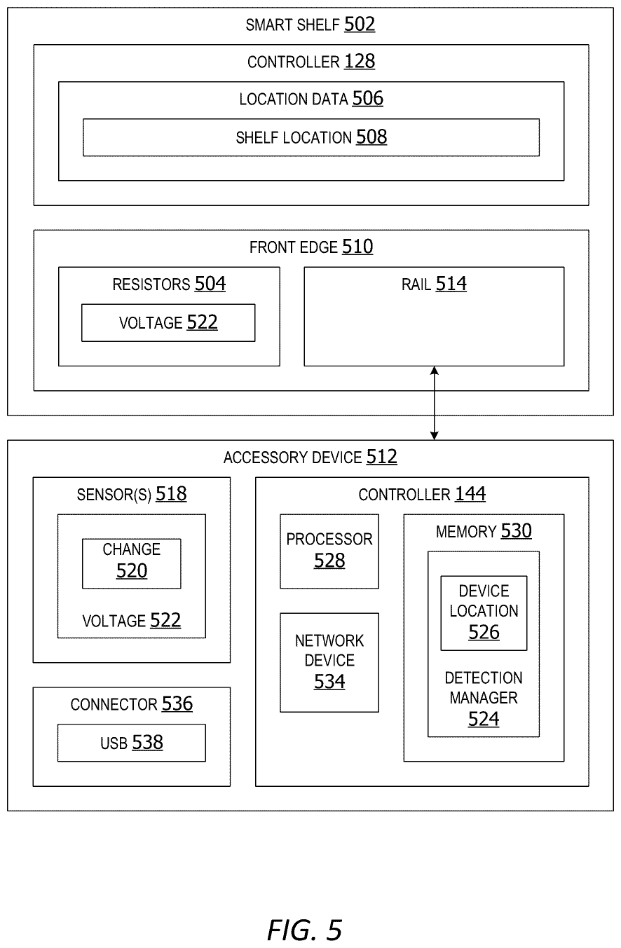

In some examples, a smart shelf support member 412 is a vertical shelf support member having a plurality of slots 108 along the vertical length of the smart shelf support member 104. A shelf 106 in a set of shelves 105 includes a support arm 404 having a plug 114 mounted to an end of the support arm 404. The support arm 404 removably attaches to one or more of the slots in the plurality of slots 108. The plug 114 engages a contact surface 118 associated with a slot 110 on the shelf support member. In some examples, the shelf 106 is a smart shelf having a resistor stack embedded within the shelf 106, as is shown in FIG. 5 below.

In some examples, a converter box 146 provides electrical power to the smart shelf support member 412. A voltage runs through the resistor stack 402. A sensor 406 on the shelf 106 detects a change in voltage 408 as the current runs through the series of resistor(s) 410. The sensor 406 is any type of sensor device for measuring or detecting voltage changes across one or more resistors, such as, but not limited to, a voltmeter.

A controller 128 includes a location manager 218. The location manager 218 is a software component that determines a location of the shelf based on the voltage 408 through the resistor stack 402. As the voltage moves down through the series of resistors in the stack, the voltage decreases. This decrease in voltage enables the location manager to estimate the location of the shelf on the set of shelves and/or estimate a height of the shelf 106 above the ground. The location manager generates the location data 414, including the estimated height of the shelf, using the voltage data generated by the sensor 406. The controller 128 sends the location data 414 to any accessories having a wired or wireless connection with the controller, such as, but not limited to, the accessory device 418 in FIG. 4.

In some examples, the shelf optionally includes an analog-to-digital converter (ADC) used by the location manager to convert analog data into digital data. The ADC (not shown) can also be used to convert digital data into analog data.

In some examples, a sensor associated with a shelf detects a first change in voltage across a first resistor in the plurality of resistors within the smart shelf support member. The first change in voltage is associated with a first notch at a first location in the plurality of notches on the smart shelf support member. If a sensor associated with a shelf detects a second change (two change units) in the voltage across a second resistor in the plurality of resistors indicating twice the voltage change than the change detected at the first resistor, the second change in voltage is associated with a second notch at a second location in the plurality of notches on the smart shelf support member.

Likewise, if a sensor associated with a shelf removably attached to the smart shelf support member detects a third change in voltage (a decrease of three units) across a third resistor in the plurality of resistors, the third change in voltage is identified as belonging to a third notch at a third location in the plurality of notches on the smart shelf support member. In this manner, the shelf controller can determine the location of the shelf on the smart shelf support member (notch number) based on the amount of decrease in the voltage detected by the sensor on the shelf when the sensor engages a contact point within the notch. The contact point brings the sensor into contact with or within range of the voltage such that the sensor can detect changes in the voltage across one or more of the resistors in the plurality of resistors of the resistor stack.

Thus, a voltmeter or other sensor associated with a shelf measures the voltage change across a resistor in the resistor stack. The voltage change is equivalent to the sum of the change in voltage across the resistors through which the voltage has already traveled. If a voltage change is being read at a fourth resistor in the stack, the change in voltage is equal to the sum of the change in voltage across all four resistors in the stack through which the voltage has passed. Therefore, the controller of the shelf and/or an accessory device can determine the resistor number as well as the corresponding location of the resistor based on the voltage change.

In some examples, the location of the shelf is identified using a slot identifier or slot number to identify the slot in the plurality of slots to which the shelf is removably attached. In other examples, the slot is identified using a height measurement, such as inches above a floor, inches along the vertical smart shelf support member, feet above the floor, or any other height measurement.

In this example, the system 400 is depicted as a separate system from the system 100 as shown in FIG. 1, the system 200 shown in FIG. 2 and the system 300 in FIG. 3. However, in other examples, the system 400 incorporates one or more of the elements from FIG. 1, FIG. 2, and/or FIG. 3 in addition to the elements shown in FIG. 4. For example, the system 200 can optionally include one or more of the processor 130 and the memory 132 shown in FIG. 1, the network device 222 shown in FIG. 2 and/or the notch 308 and the notch 314 shown in FIG. 3.

FIG. 5 is an exemplary block diagram illustrating a smart shelf 502 having a stack of two or more resistors 504 in series for improved location detection of devices on the smart shelf 502. The smart shelf 502 is a shelf having a controller 128 for obtaining location data 506, including a shelf location 508 on a modular display having a set of shelves. The smart shelf 502, in some examples, is a shelf such as, but not limited to, the shelf 106 in FIG. 1, the shelf 204 in FIG. 2, the shelf 302 in FIG. 3 and/or the shelf 106 in FIG. 4.

In some examples, the smart shelf 502 includes a series of two or more resistors 504 within the front edge 510 and/or along an interior of the front edge 510 of the smart shelf 502. The front edge 510 is the customer facing the edge of the smart shelf 502. Items for display are placed on a top surface of the smart shelf 502 and/or incorporated within the surface of the smart shelf 502. The front edge 510 is the edge of the smart shelf optionally containing electronic shelf labels and other signage identifying item prices and other item-related information for viewing by customers. In some examples, electronic shelf labels and other accessory devices, such as the accessory device 512, removably attached to a location along a rail 514 on the front edge 510. In some examples, an electronic shelf label clips onto a portion of the rail and engages a resistor contact point via an accessory device connection port in the smart shelf.

One or more sensor(s) 518 detect a change in voltage 522 running through the stack of resistors 504. A detection manager 524 analyzes the voltage 522 change 520 to generate an estimated device location 526. The detection manager 524 includes hardware, firmware, and/or software configured to determine the height of a shelf above a surface. The height can be an exact height or an approximate height.

The estimated device location 526 is an estimate of the position of the accessory device 512 on the rail. For example, if the accessory device 512 is an electronic shelf label, the electronic shelf label can be clipped onto the rail at the right end of the rail, at the left end of the rail, in the center of the rail, in a position between the right end of the rail and the center, in a position between the left end of the rail and the center, etc. Each possible location along the rail is assigned an identifier. The detection manager 524 detects the change in voltage of the current along the resistors and uses the detected change to estimate which possible location along the rail the accessory device 512 is currently located.

In this manner, the smart shelf 502 provides the location of the smart shelf 502 to the accessory device. The location data 506 includes the shelf support member UID, the notch number and/or height of the shelf above a surface. The accessory device 512 uses the voltage change through the resistors to determine a more precise location of the accessory device on the smart shelf 502 itself from a plurality of possible locations on the smart shelf and/or the edge of the smart shelf.

In some examples, the controller 144 includes a processor 528 for executing computer-executable instructions. The processor 528 is a processor, such as, but not limited to, the processor 111 and/or the processor 130 in FIG. 1. The controller 144 includes a memory 530 storing the location data 506 and/or application, such as the detection manager 524. The memory 530 is a memory device for storing data, such as, but not limited to, the memory 113 and/or the memory 132 in FIG. 1. In still other examples, the accessory device optionally includes a network device 534. The network device is a device for enabling wired or wireless communications, such as, but not limited to, the network device 222 in FIG. 2.

In still other examples, the accessory device 512 includes a connector 536. The connector is a plug or other connection device for connecting the accessory device 512 to a source of power and/or a source of data, such as, but not limited to, the controller 128 on the smart shelf 502. The connector 536 in this example is a USB 538. However, the examples are not limited to a USB connector. Any type of wired connection may be used to connect the accessory device to the smart shelf 502 at a connection port enabling transfer of location data and/or power to the accessory device. In this example, the sensor(s) 518 detect the voltage change via the connector 536. In other examples, the sensor(s) 518 detect the voltage change through a contact point or other contact surface on the rail. The voltage change across one or more resistors is detected via a sensor device measuring the voltage change across the one or more resistors. The voltage change is used to identify a location identifier on the shelf. The location identifier is any type of identifier enabling the system to determine a precise location or approximate location of the accessory device on the shelf. The location identifier in some examples is a connection port number identifying a port into which the accessory device is plugged into the shelf. In other examples, the identifier is a length measurement, such as a number of inches from one end of the shelf.

In these examples, an accessory device, such as a digital shelf label, attached to the edge of the shelf at a first position closest to the left edge of the shelf can be identified as one inch or located at inch number one. A shelf label located approximately half-way across a shelf that is one foot long can be identified as being located at inch number six or six inches from the left side of the shelf edge. In another example, a digital shelf label located at the far edge of a shelf that is sixty inches long can be identified as being located at inch number 60 or sixty inches.

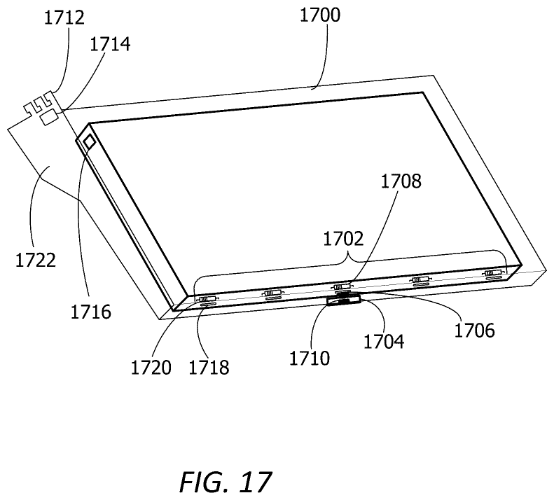

In some examples, a connector on the accessory device removably attaches to the connection port on the smart shelf, such as, but not limited to, a USB connector on an accessory device inserting into a USB connection port on the shelf, as shown in FIG. 17 below. However, the embodiments are not limited to a USB connector connecting to a USB connection port on the smart shelf. In other examples, the connector is any type of connector capable of attaching to any type of connection point on the smart shelf.

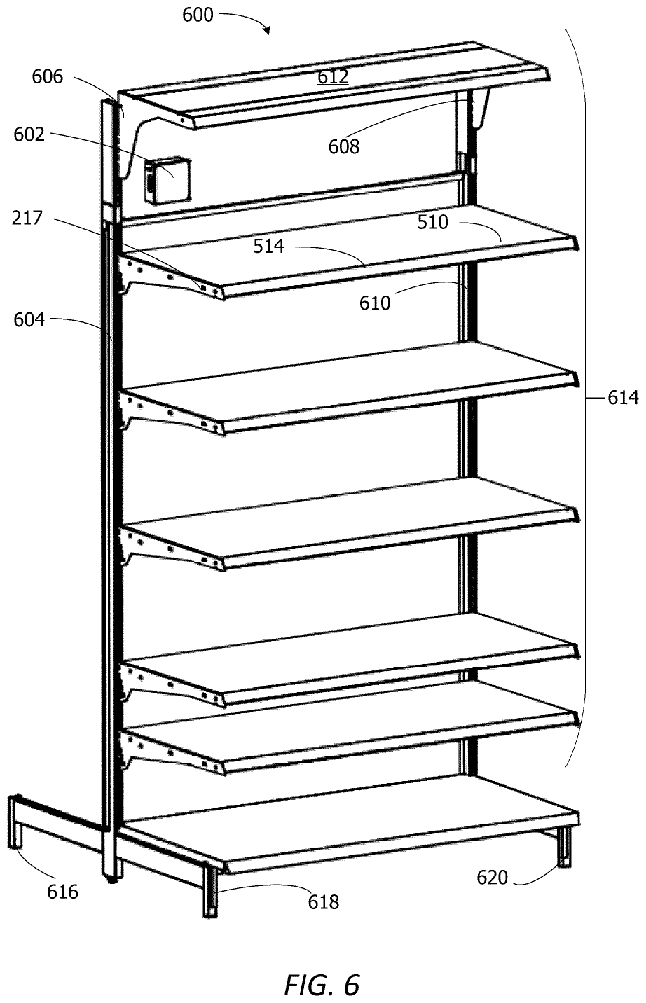

Turning now to FIG. 6, an exemplary illustration of a set of shelves 614 having smart shelf height detection is shown. In this example, the set of shelves 614 includes a vertical smart shelf support member 604. The smart shelf support member 604 includes a set of resistors embedded within the smart shelf support member 604. The vertical smart shelf support member 604 is a shelf support member, such as, but not limited to, the smart shelf support member 412 in FIG. 4. A change in voltage across the resistors is detectable by one or more of the shelves of the set of shelves 614.

Each shelf of the set of shelves 614 is supported by a support arm. For example, the shelf 612 is supported by a first support arm 606 and a second support arm 608. Each support arm connects to a vertical shelf support member. The shelf 612 is a shelf supported by at least one shelf support arm removably attached to a vertical shelf support member, such as, but not limited to, the shelf 106 in FIG. 1, the shelf 204 in FIG. 2, the shelf 302 in FIG. 3, the shelf 106 in FIG. 4 and/or the shelf 502 in FIG. 5. In some examples, the shelf 612 is optionally a smart shelf having a set of resistors embedded within the shelf, such as, but not limited to, the smart shelf 502 in FIG. 5 above.

The support arm 606 is a support arm removably connected to a vertical shelf support member, such as, but not limited to, the support arm 606 is a first support arm having a plug for connecting to a data port on the vertical support member, such as, but not limited to, the support arm 306 in FIG. 3 and/or the support arm 404 in FIG. 4. The second support arm is a support arm for supporting a portion of a shelf, such as, but not limited to, the support arm 312 in FIG. 3.

The set of shelves 614 includes a controller 602 having a processor and a memory for detecting shelf height. The set of shelves and the shelf support member are part of a shelf location detection system 600, such as, but not limited to, the shelf location detection system 100 in FIG. 1, the shelf location detection system 200 in FIG. 2, the shelf location detection system 300 in FIG. 3, and/or the shelf location detection system 400 in FIG. 4.

In this example, the controller 602 is attached to a back member of the shelf or a back wall behind the shelf. In other examples, the controller is attached to the smart vertical support member 604, one of the shelves in the set of shelves 105, or any other portion of the set of shelves 614. The controller 602 communicates wirelessly with the set of shelves 614, in this example. However, in other examples, the controller 602 is connected to the smart vertical shelf support member 604 and/or another portion of the set of shelves 614 via one or more wires.

A second vertical shelf support member 610 is paired with the corresponding vertical smart shelf support member 604. Shelves are removably connected to the shelf support member 604 via the support arm 606 on one side of the shelf while a support arm 608 on the opposite side of the shelf is attached to the corresponding second vertical shelf support member 610. In this manner, a pair of shelf support members supports one or more shelves which are removably attached to the shelf support members 604 and 610 via a support arm on each side which fits into a slot on each support member.

In this example, the smart shelf support member 604 includes a stack of resistors inside the smart shelf support member 604 housing. The system detects a change in voltage down the stack to determine the estimated height of each shelf in the set of shelves 105. The height, in this example, is identified as a slot number identifying a slot on the smart shelf support member 604 into which a shelf support arm is removably attached. In other examples, the height is identified as a slot number associated with at least one slot in a range of slots into which the shelf support arm is removably attached. In these examples, the height is not precisely identified, however, a location of a slot within a close range of the actual slot into which the shelf is attached. This proximate slot UID enables the system to determine a height or location of the shelf within an acceptable range of slots such that accessory devices can be calibrated correctly even if the location is not precise. In other words, the location of the shelf does not have to be precise as long as the location is determined within an acceptable range of slots from the actual location of the shelf on the smart shelf support member.

In some examples, electronic shelf labels and other accessory devices, such as the accessory device 512, removably attached to one or more locations along a rail 514 on the front edge 510. In some examples, an electronic shelf label clips onto a portion of the rail at an attachment point.

In other examples, the shelf optionally includes one or more connection ports for connecting one or more accessory devices to the smart shelf, such as a connection port 217. In this example, the connection port 217 is located on a side of the shelf. In other examples, the connection port 217 is located on an underside of the shelf, along the front edge of the shelf, or on the top surface of the shelf. The port can be implemented as a data port, such as a universal serial bus (USB) port. A USB port includes any type of USB port, such as a USB-A, USB-B, USB-C, lightning, etc.

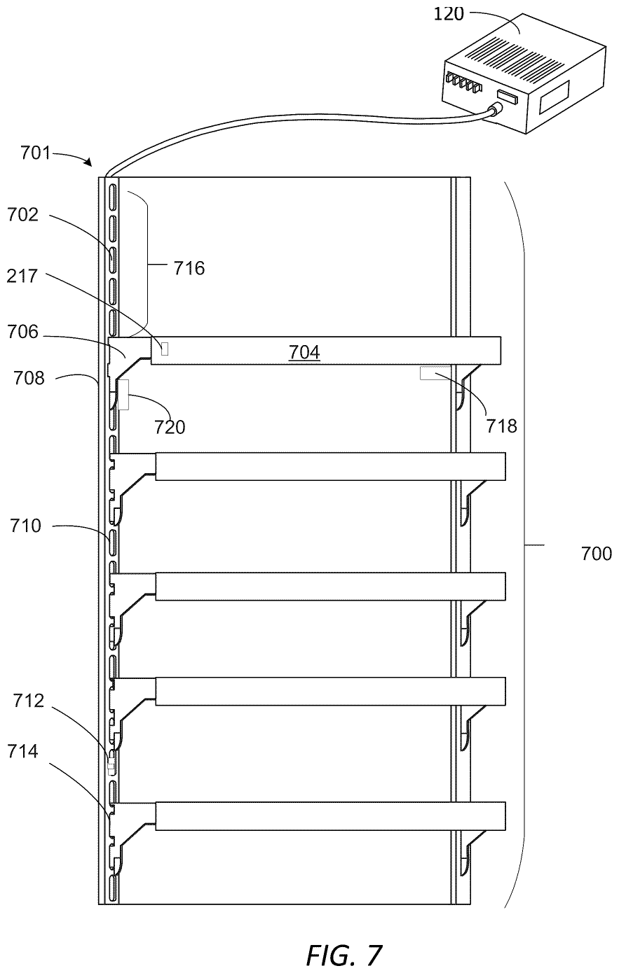

In this example, the set of shelves are supported on a stand or bottom support members, such as the foot 616, the foot 618, and the foot 620. However, in other examples, the set of shelves include wall mounted shelves as is shown in FIG. 7 below. In still other examples, the set of shelves include gondola shelves, shelves within a display case, or any other type of shelving.

FIG. 7 is an exemplary block diagram illustrating a set of shelves 700 having a controller box associated with the set of shelves. The set of shelves and controller box are part of a shelf location detection system 701. The shelf location detection system 701 is a system such as, but not limited to, the shelf location detection system 100 in FIG. 1, the shelf location detection system 200 in FIG. 2, the shelf location detection system 300 in FIG. 3, and/or the shelf location detection system 400 in FIG. 4.

In this non-limiting example, the electronic shelf display accessory devices receive power and location data from one or more shelves within the set of shelves 700 receiving power from a power bus 702 within the vertical shelf member via a mounting plug on each power shelf. The power bus 702 receives power from a converter box located above the set of shelves. In other examples, the converter box is attached to the highest shelf in the set of shelves. Power flows from the converter box down the power bus to each power shelf. Location data is obtained from the vertical shelf support member, which provides the data to each shelf. The shelves provide the data to the accessory devices.

In other examples, the shelves optionally include one or more accessory device connection ports for connecting one or more accessory devices to the shelf, such as the connection port 217. In this example, the connection port 217 is located on the front edge of a shelf 704. In other examples, the connection port 217 is located on a side of the shelf, as shown in FIG. 6. In still other examples, the connection port 217 is located on the underside (bottom) of the shelf, or on the top surface of the shelf. The port can be implemented as a data port, such as a universal serial bus (USB) port.

The shelf 704 is supported by a pair of support arms, such as, but not limited to, the shelf support arm 706. The shelf support arm 706 removably attaches to the vertical smart shelf support member 708 via one or more notches, such as the notch 710. In this example, the shelf is removably mounted to the vertical smart shelf support member via a mounting bracket 714 on each shelf support arm configured to removably couple to a shelf support notch in the plurality of notches. In this example, a portion of notches in the plurality of notches without any mounting brackets attached are shown at 716.

The set of shelves 700 includes a stack of resistors 712 within an interior of the smart shelf support member 708. The stack of resistors 712 in this example is visible through one of the notches. However, in other examples the resistors are not visible through the notches.

A resistor in the stack of resistors is associated with each notch in the smart shelf support member. Thus, if the smart shelf support member 708 includes twenty notches, the stack of resistors within the smart shelf support member also includes approximately twenty resistors embedded within the smart shelf support member. The voltage running through the resistors decreases as the voltage flows through the resistors. Therefore, the voltage is lowest as it passes through the last resistor in the stack and the voltage is highest (greatest) as it passes through the first resistor in the stack. In this manner, the controller associated with each shelf can determine which notch the shelf is removably attached based on the voltage change.

For example, if the voltage change from one resistor to another is relatively fixed (one unit of change), and a shelf controller determines the voltage has changed by two units (two times), the controller determines the shelf is attached at the second notch from the top, assuming the power source is flowing downward through the smart shelf support member 708 from the top down to the bottom. Likewise, a controller for a shelf at the tenth notch should detect a change in voltage that is approximately ten times the change in voltage from the first notch.

If the power is flowing up through the smart shelf support member from the bottom up to the top, the change in voltage is least (greatest voltage) when detected by a shelf attached at the notch nearest the bottom (first from the bottom). The overall voltage change detected by a controller in a shelf attached at the top of the vertical smart shelf support member is greatest because the smallest amount of voltage remains moving through the final resistor in the stack.

Each shelf in the set of shelves optionally includes a controller, such as, but not limited to, the controller 128 in FIG. 1. In this example, the controller for the shelf 704 is located on an exterior underside (bottom) of the shelf 704. In other examples, the controller is located within an interior of the shelf itself. In still other examples, the controller is located on a side of the shelf, on top of the shelf, or otherwise integrated within one or more parts of the shelf 704.

The vertical smart shelf support member 708 includes a controller 720 which transmits location data to the controller 718 of the shelf 704. In this example, the controller 720 is shown on an exterior of the vertical support member 708. However, in other examples, the controller is implemented on a circuit board or other controller device integrated within the vertical smart shelf support member 708.

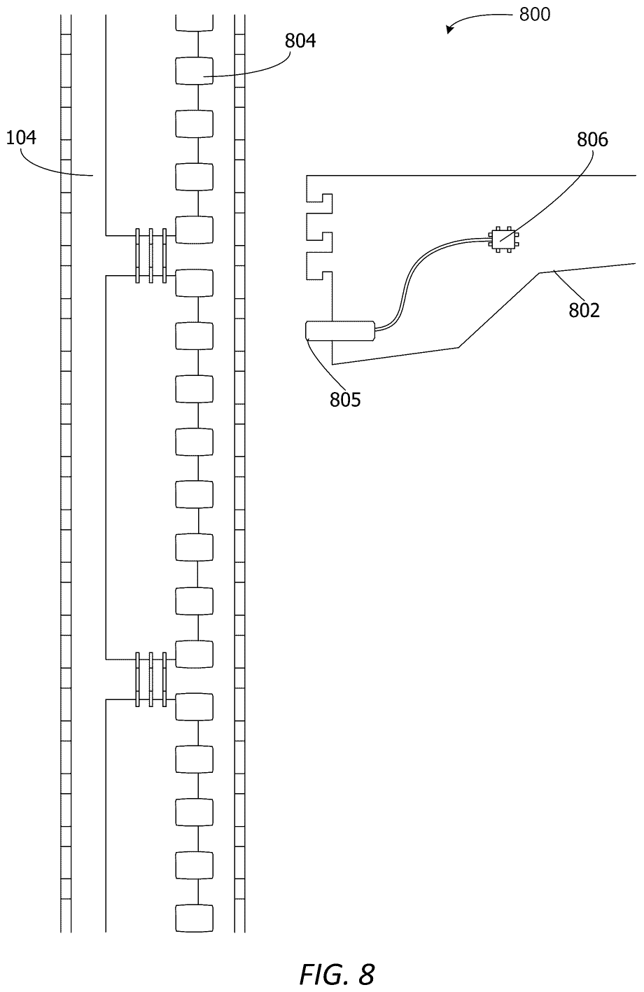

FIG. 8 is an exemplary illustration of a cross-section view 800 of a vertical shelf support member 104 and a shelf support arm 802. The vertical shelf support member 104 includes a series of serial data ports 804 within the vertical shelf support member. The shelf support member 104 is a shelf support in a shelf location detection system, such as, but not limited to, the shelf location detection system 100 in FIG. 1, the shelf location detection system 200 in FIG. 2, the shelf location detection system 300 in FIG. 3, and/or the shelf location detection system 400 in FIG. 4.

In other examples, the vertical shelf support member includes a series of resistors in a stack. A sensor 806 detects the changes in the voltage through the resistors to determine the height of shelf associated with the support arm 802.

The support arm, in this example, includes hooks or teeth that are configured to fit within slots on the vertical shelf support member. The support arm in this example includes a connector 805 for connecting a controller of the shelf with a data port of the vertical shelf support member. Location data in some examples is transmitted to the controller of the shelf via the connector 805.

In other examples, the support arm includes a sensor 806 for detecting sensor data. In some examples, the sensor 806 detects when the connector is properly seated within the notch and connected to the vertical shelf support member. In other examples, the sensor detects changes in voltage through a stack of resistors within the vertical shelf support member.

The notches on the vertical shelf support member are assigned a number or other identifier. In this example, some of the notches are number 3.1, 3.2, 3.3, etc. However, the examples are not limited to a number identifier. In other examples, the notches are assigned any type of identifier. The identifier can include letters, numbers, symbols, or any other type of identifier.

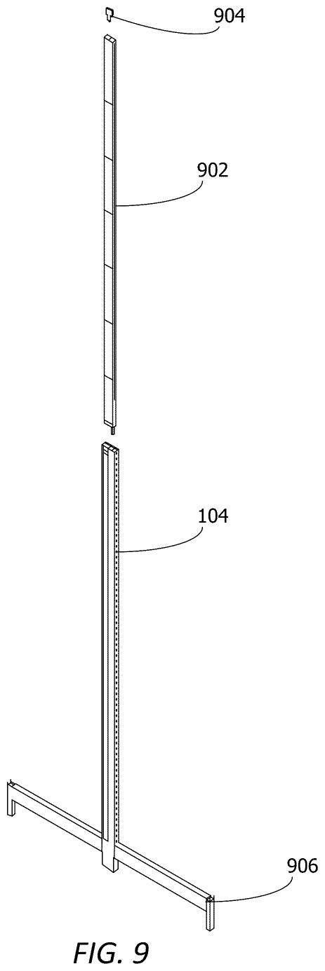

FIG. 9 is an exemplary illustration of a partially exploded view of a vertical shelf support member 104 having an insulating upright insert stack 902. The vertical shelf support member 104 is a shelf support member in a shelf location detection system, such as, but not limited to, the shelf location detection system 100 in FIG. 1, the shelf location detection system 200 in FIG. 2, the shelf location detection system 300 in FIG. 3, and/or the shelf location detection system 400 in FIG. 4.

The insert stack in some examples includes a series of serial ports within an interior of the vertical shelf support member 104. In other examples, the insulating upright insert stack includes a stack of resistors.

The vertical shelf support member 104 in this example is attached to a base member 906. A cap 904 is optionally included in a top portion of the vertical shelf support member. The cap is removable to enable access to the stack within the vertical shelf support member.

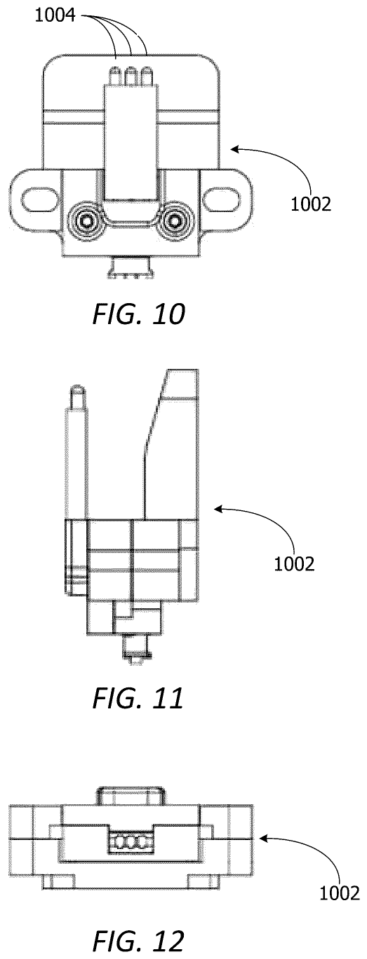

FIG. 10 is an exemplary illustration of a plug 1002 on a shelf support arm for connecting to the vertical shelf support member. The plug 1002 includes connector(s) 1004 for engaging the plug with a port or other contact surface associated with the vertical shelf support member. FIG. 11 is an exemplary illustration of a side view of the plug 1002 for a shelf support arm. FIG. 12 is an exemplary illustration of a top view of the plug 1002 for the shelf support arm.

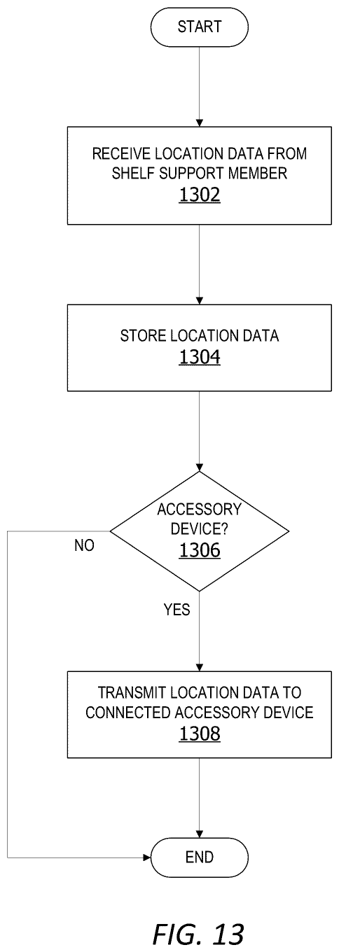

FIG. 13 is an exemplary flow chart illustrating operation of the controller device on the shelf to provide location data to accessory devices for self-configuration. The process shown in FIG. 13 is performed by a location manager component, executing on a processor, such as the controller 128 in FIG. 1.

The process begins by receiving location data from a shelf support member controller at 1302. The location data is received via a serial data bus in the vertical shelf support member engaging a plug on the shelf support arm. The shelf controller stores the location data on a memory or other data store of the controller at 1304. The controller determines whether an accessory device is connected to the shelf at 1306. An accessory device connects to the shelf via a wired or wireless connection. If an accessory device is not connected, the process terminates thereafter.

If an accessory device is connected at 1306, the shelf controller transmits location data to the connected accessory device at 1308. A controller of the accessory device receives and stores the location data. The accessory device can utilize the location data for full or partial self-configuration. The process terminates thereafter.

While the operations illustrated in FIG. 13 are performed by a controller device or other computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 13.

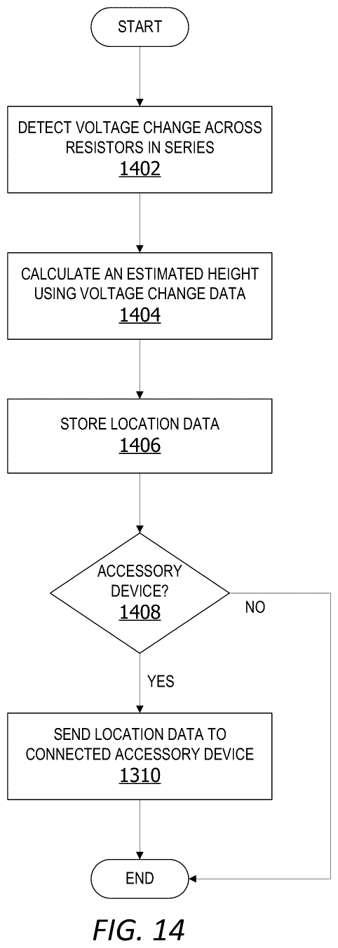

FIG. 14 is an exemplary flow chart illustrating operation of the controller device of the shelf to provide an estimated height of the shelf above ground to accessory devices for self-configuration. The process shown in FIG. 14 is performed by a location manager component, executing on a processor, such as the controller 128 in FIG. 1.

The process begins by detecting a voltage change across a series of resistors on the vertical shelf support member at 1402. The controller on the shelf calculates an estimated height of the shelf above the floor using the voltage change data at 1404. The estimated height is location data. The location data is stored on a memory or other data storage on the shelf at 1406. The controller determines if an accessory device is connected to the shelf at 1408. If an accessory device is not connected, the process terminates thereafter. If an accessory device is connected at 1408, the controller sends the location data to the connected accessory device at 1410. The process terminates thereafter.

While the operations illustrated in FIG. 14 are performed by a controller device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

Referring again to FIG. 15, an exemplary block diagram illustrates a system 100 for determining a location of a shelf. In the example of FIG. 15, the computing device 1502 represents any device executing computer-executable instructions 1504 (e.g., as application programs, operating system functionality, or both) to implement the operations and functionality associated with the computing device 1502. The computing device 1502 can be referred to as a controller device, such as, but not limited to, the controller 120 and/or the controller 128 in FIG. 1.

The computing device 1502, in some examples includes a mobile computing device or any other portable device. A mobile computing device includes, for example but without limitation, a mobile telephone, laptop, tablet, computing pad, netbook, gaming device, and/or portable media player. The computing device 1502 can also include less-portable devices such as servers, desktop personal computers, kiosks, or tabletop devices. Additionally, the computing device 1502 can represent a group of processing units or other computing devices.

In some examples, the computing device 1502 has at least one processor 1506 and a memory 1508. The computing device 1502, in other examples optionally includes a user interface component 1510.

The processor 1506 includes any quantity of processing units and is programmed to execute the computer-executable instructions 1504. The processor 1506 is a processor such as, but not limited to, the processor 111 and/or the processor 130 in FIG. 1. The computer-executable instructions 1504 is performed by the processor 1506, performed by multiple processors within the computing device 1502 or performed by a processor external to the computing device 1502. In some examples, the processor 1506 is programmed to execute instructions such as those illustrated in the figures (e.g., FIG. 12, FIG. 13, and/or FIG. 14).

The computing device 1502 further has one or more computer-readable media such as the memory 1508. The memory 1508 includes any quantity of media associated with or accessible by the computing device 1502. The memory 1508 is a memory device, such as, but not limited to, the memory 113 and/or the memory 132 in FIG. 1. The memory 1508, in these examples, is internal to the computing device 1502 (as shown in FIG. 15). In other examples, the memory 1508 is external to the computing device (not shown) or both (not shown).

The memory 1508 stores data, such as one or more applications. The applications, when executed by the processor 1506, operate to perform functionality on the computing device 1502. The applications can communicate with counterpart applications or services such as web services accessible via a network 1512. In an example, the applications represent downloaded client-side applications that correspond to server-side services executing in a cloud.

The memory stores data and/or applications, such as, but not limited to, the computer-executable instructions 1504 and/or the location manager 218. In other examples, the memory stores a detection manager, such as, but not limited to, the detection manager 524 in FIG. 5.

In other examples, the user interface component 1510 includes a graphics card for displaying data to the user and receiving data from the user. The user interface component 1510 can also include computer-executable instructions (e.g., a driver) for operating the graphics card. Further, the user interface component 1510 can include a display (e.g., a touch screen display or natural user interface) and/or computer-executable instructions (e.g., a driver) for operating the display. The user interface component 1510 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 1502 in one or more ways.

The network 1512 is implemented by one or more physical network components, such as, but without limitation, routers, switches, network interface cards (NICs), and other network devices. The network 1512 is any type of network for enabling communications with remote computing devices, such as, but not limited to, a local area network (LAN), a subnet, a wide area network (WAN), a wireless (Wi-Fi) network, or any other type of network. In this example, the network 1512 is a WAN, such as the Internet. However, in other examples, the network 1512 is a local or private LAN.

In some examples, the system 1500 optionally includes a communications interface device 1514. The communications interface device 1514 is a device for creating a wired or wireless connection between the computing device and one or more other network enabled devices, such as, but not limited to, the network device 222 in FIG. 2 and/or the network device 534 in FIG. 5.

The communications interface device 1514 includes a network interface card and/or computer-executable instructions (e.g., a driver) for operating the network interface card. Communication between the computing device 1502 and other devices, such as but not limited to a user device 1516 and/or a cloud server 1518, can occur using any protocol or mechanism over any wired or wireless connection. In some examples, the communications interface device 1514 is operable with short range communication technologies such as by using near-field communication (NFC) tags.

The user device 1516 represents any device executing computer-executable instructions. The user device 1516 can be implemented as a mobile computing device, such as, but not limited to, a wearable computing device, a mobile telephone, laptop, tablet, computing pad, netbook, gaming device, and/or any other portable device. The user device 1516 includes at least one processor and a memory. The user device 1516 can also include a user interface component.

The cloud server 1518 is a logical server providing services to the computing device 1502 or other clients, such as, but not limited to, the user device 1520. The cloud server 1518 is hosted and/or delivered via the network 1512. In some non-limiting examples, the cloud server 1518 is associated with one or more physical servers in one or more data centers. In other examples, the cloud server 1518 is associated with a distributed network of servers.

The system 100 can optionally include a data storage device 1520 for storing data, such as, but not limited to location data 1522 and/or height data 1524. The data storage device 1520 can include one or more different types of data storage devices, such as, for example, one or more rotating disks drives, one or more solid state drives (SSDs), and/or any other type of data storage device. The data storage device 1520, in some non-limiting examples, includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 1520 includes a database.

The data storage device 1520 in this example is included within the computing device 1502, attached to the computing device, plugged into the computing device, or otherwise associated with the computing device 1502. In other examples, the data storage device 1520 includes a remote data storage accessed by the computing device via the network 1512, such as a remote data storage device, a data storage in a remote data center, or a cloud storage.

The location data 1522 is data associated with the location of a shelf and/or the location of an accessory on a shelf, such as, but not limited to, the location data 126 in FIG. 1, the location data 414 in FIG. 4 and/or the location data 506 in FIG. 5. The height data 1524 is data associated with the height of a shelf above the floor or other surface. The height data in some examples includes an exact or approximate measurement of height or distance above a surface, such as, but not limited to, the height 138 in FIG. 1 and/or the height 210 in FIG. 2.

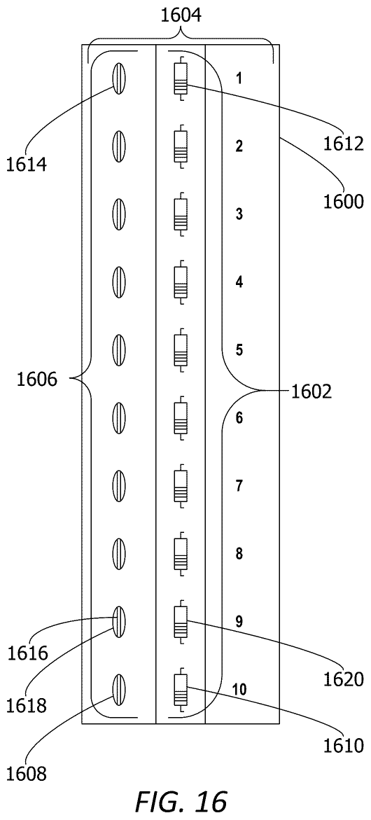

Turning now to FIG. 16, an exemplary block diagram illustrating a cross section view of a smart shelf support member 1600 having a plurality of resistors 1602 embedded within an interior 1604 of the smart shelf support member 1600 is shown. Each resistor in the plurality of resistors 1602 corresponds to a notch in the plurality of notches 1606. For example, notch 1608 is the lowest notch (closes to the floor) in the plurality of notches 1606. Notch 1608 corresponds to resistor 1610 in the plurality of resistors 1602 in the resistor stack. Likewise, the topmost resistor 1612 corresponds to the topmost notch 1614. A sensor in the shelf support arm of a shelf (not shown) engages a contact point 1616 associated with a notch, such as the notch 1618 to read or measure the voltage change across the corresponding resistor. In this example, the contact point sits within an interior space of the smart shelf support member that is accessible via the notch 1618.

The notch 1618 is an opening or access point that corresponds to the resistor 1620, in this example. A sensor associated with a shelf support arm removably attached to the smart shelf support arm 1600 via the notch 1618 measures the voltage change occurring across the resistor 1620 as the voltage moves down through the resistor stack from the first resistor 1612 in the stack down to the last resistor 1610 in the stack.

In this example, the notches are oval shaped openings in the smart shelf support member. However, the embodiments are not limited to oval shaped openings. The notches can be implemented as round openings, square-shaped openings, rectangular shaped openings, or any other shaped openings.

The plurality of notches in the example shown in FIG. 16 includes ten notches. However, the embodiments are not limited to ten notches in a smart shelf support member. In other embodiments, the smart shelf support member includes any number of notches. For example, the smart shelf support member can include, without limitation, forty notches, a hundred notches or any other number of notches.

FIG. 17 is an exemplary block diagram illustrating a cross section view of a smart shelf 1700 having a plurality of resistors 1702 embedded within the smart shelf support member in a series. In this example, each resistor corresponds to an accessory device connection port of the smart shelf for connecting an accessory device to the smart shelf 1700, such as, but not limited to, the accessory device 1704. In this example, the accessory device 1704 is a digital shelf label. However, the embodiments are not limited to digital shelf labels. The accessory device 1704 can include any type of accessory device, such as, but not limited to, a light, a camera, a motion sensor, etc.

The accessory device 1704 includes a controller 1710. The controller 1710, in this example, includes a processor, a memory, and a sensor for detecting a voltage change across a resistor corresponding to a connector at which the accessory device is connected to the smart shelf 1700.

In this example, the accessory device 1704 connects to the smart shelf 1700 via an accessory device connection port 1706. The accessory device connection port 1706 in this non-limiting example is a USB port. A sensor in the accessory device 1704 measures a voltage change across the one or more resistors in the plurality of resistors 1702. In this example, the resistor 1708 in the plurality of resistors corresponds to the connection port 1706 in which the accessory device 1704 is connected to the smart shelf 1700.

The smart shelf 1700 optionally includes one or more shelf support arms, such as, but not limited to, the shelf support arm 1722. The shelf support arm 1722 includes a mounting bracket 1712. The mounting bracket 1712, in this example, includes three hooks at the end of the mounting bracket for engaging one or more notches in a smart shelf support member. However, the embodiments are not limited to three hooks at the end of the mounting bracket. The mounting bracket includes any type of mounting device and is not limited to hooks at the end of the mounting bracket. In some examples, the mounting bracket includes no hooks, a single hook, two hooks, or four or more.

A sensor 1714 associated with the smart shelf 1700 detects a change in voltage across a resistor within the smart shelf support member when the mounting bracket 1712 is inserted into one or more notches within the smart shelf support member. In other words, a change in voltage across a resistor is measured by the sensor 1714 when the mounting bracket of the support arm engages the contact surface associated with the one or more notches of the smart shelf support member. In this example, the sensor 1714 is a sensor device for registering changes in voltage, such as a voltmeter.

In some examples, a controller 1716 of the smart shelf includes a processor, a memory, and/or a data storage device. The change in voltage is analyzed via the processor. The controller determines the location of the shelf using the voltage change data. In some examples, the location data identifying a location (notch number/notch identifier) of the shelf on the smart shelf support member is stored on the memory or on a data storage device. The controller 1716 transmits the location data identifying the smart shelf support member and the notch(es) at which the smart shelf is attached to the smart shelf support member to the accessory device 1704 connected to the smart shelf at a connection point, such as, but not limited to, an accessory device connection port.

In this example, the sensor 1714 is implemented as a separate device from the controller 1716. The sensor 1714 provides the measured voltage change data to the controller 1716 via a wired or wireless communication. However, in other examples, the sensor 1714 is integrated within the controller 1716.

In this example, a sensor within the accessory device 1704 detects a voltage change across a resistor corresponding to a connection port at which the accessory device is connected to the smart shelf 1700. Each accessory device on the smart shelf 1700 connects to the smart shelf 1700 via a connection port, such as, but not limited to, the connection port 1718. Each resistor in the set of resistors corresponds to an accessory device connection port in the set of connection ports on the smart shelf. For example, the resistor 1720 is paired with the accessory device connection port 1718. The accessory device connection port 1718, in some examples, is a USB port.

In other examples, the sensor detecting the change in voltage through the resistor 1708 within the smart shelf resistor stack is implemented separately from the controller 1710. The sensor, in these examples, transmits the voltage change data to the controller 1710 via wired or wireless communications.

The smart shelf in this example includes accessory device connection ports (connection points) along the front edge of the shelf. However, the embodiments are not limited to connection ports on the front edge of the shelf. In other embodiments connection ports for connecting accessory devices to the smart shelf are provided on an underside of the smart shelf, at the back of the smart shelf, along one or more sides of the smart shelf, or any other location on the smart shelf.

### Additional Examples

In some examples, the system allows a shelf to detect its installation height. This is accomplished by equipping the shelf with a plug. A stack of resistors is installed in the vertical component of the shelf. The resistor stack creates a cascading voltage down the length of the shelf. Each slot in the vertical shelf support member is equipped with a contact surface which can be engaged by the shelf plug. The shelf uses an analog to digital converter (ADC) to measure the voltage level and calculate height based on the voltage change. In other examples, the voltage change is detected by a sensor, such as a voltmeter. In these examples, the shelf uses the data associated with voltage change relative to the ground where it is installed to determine how high above the ground the shelf is located. The height determination made using the voltage change is an estimate of altitude.

The shelf, in other examples, includes a series of resistors inside the shelf near a front edge of the shelf. An accessory plugged into the shelf detects the change in voltage across the resistors. This voltage change information is used by a controller on the accessory device to determine an estimated position of the accessory device on the shelf edge. For example, the accessory device can determine whether it is located near a right side of the shelf, the left side of the shelf or the center of the shelf based on the detected voltage change across the series of resistors in the shelf.

In other examples, the system includes a shelf with information about its position in a store or other retail environment with greater precision than the height estimation which can be calculated using detected voltage change data associated with the stack of resistors. The shelf support member has notches. Each notch is linked to a serial data port. Each shelf has a plug that interacts with a contact associated with the notch. The shelf receives data about where it is located in the store via the data port. Equipment attached on the shelf self-configures using the location data.

Any technology on the shelf can obtain location data from the shelf, informing the device where the shelf is located in the store. For example, the location data can inform an accessory device that the shelf is located at notch 52 on vertical shelf support member number 9 on aisle 5. The shelf and/or the accessory devices capture the location data from the vertical smart shelf support member for use in self-configuration. This reduces modular display set-up time by as much as half for improved user efficiency setting up shelves and accessory device on modular displays.

In some examples, once an accessory device knows its location in the store, the device can connect to a store server, cloud server or remote data storage device via a network to obtain configuration data for use in self-configuration. For example, the self-configuration data can include product information obtained from a planogram or other database identifying information to be displayed by an electronic shelf label located at the accessory device's current location. In other examples, the system operates in an absence of a network or network connection.

In other examples, the controller on each shelf is a dedicated compute module that operates to calculate the current location of a shelf and/or an accessory on the shelf using information obtained from the vertical smart shelf support member. The controller includes a processor and a memory. The controller optionally also includes a sensor, network device, data storage device, transmitter, receiver, or any other device enabling the controller to obtain location-related information from the vertical smart support member and/or transmit location data to the accessory device(s) on the shelf.

In other examples, each shelf controller includes a translator which transmits data to accessory device(s) via a data port, such as a USB port. The translator can be included within the controller housing or located on the set of shelves separately from the shelf controller.

In an example scenario, each shelf is supported on a pair of shelf support members. One smart shelf support member in the pair includes a power bus, the serial data ports, and/or resistor stack. The other shelf support member in this example does not include the power bus, serial data ports or resistor stack(s). The embodiments are not limited to a pair of shelf support members. In other examples, the shelves are supported on three or more shelf support members in which at least one of the smart shelf support members includes a resistor stack.

In this manner, the shelves receive data and power from one vertical shelf support member but not the other. However, the examples are not limited to a single vertical shelf support member having a power bus, serial data ports and/or resistor stack(s). In other examples, both vertical shelf support members include a power bus, serial data port(s) and/or resistor(s) in series. The system supports shelving (connectors and contacts) on both sides of the shelf support member.

Other examples provide a series of unique serial ports to provide a low-speed one-way data connection to the shelf. This enables transmission of information about what upright shelf support member the shelf is installed on and the height of the shelf. The serial ports are installed inside of the upright shelf support member in such a way that each notch has a contact point providing its own unique port. The shelf is equipped with a plug which engages the contact point when the shelf is installed. By reading location data from this port, the shelf mounted technology can determine its location in the store. This offers greater precision of device location detection on the shelf, as well as increased flexibility for design and modification of modular displays.

In other examples, the system enables controller devices on the shelves and/or accessory devices to self-address when powered on using location information provided to the installed shelves and hardware by the controller device on the vertical shelf support member. Each shelf receives a unique ID from the vertical shelf support member, as well as the height of the shelf above the ground or other base level. This allows it to determine its location in the store. The system optionally has a termination plug installed in the bottom module of the vertical shelf support member.

The system enables implementation and set-up of shelf-mounted technology in a scalable and economic way. Without automatic localization, any replacement or movement of the shelves would necessitate site visits by a technician which leads to unacceptable down times and ballooning costs. In contrast, the system providing serial data ports and/or resistor stacks in shelving enables rapid modular set-up with greater precision and decreased costs.

In still other examples, a converter box is provided on an uppermost shelf which converts power received from a drop-down power supply from a first voltage to a lower, second voltage suitable for utilization by the one or more peripheral devices associated with one or more power shelves. This enables safe and effective delivery of power while eliminating wiring coming up from the floor, wiring wrapping around shelves from the back and/or wiring draped across or in-front of shelves. This improves the appearance and safety of the shelves.

In some examples, a shelf support member in the set of shelf support members optionally includes a power bus. The power bus runs through a hollow interior of the shelf support member. If the shelf support member is mounted vertically, the power bus also runs vertically through the central hollow cavity of the shelf support member.

The power bus runs the entire length of the shelf support member in some examples. Thus, if the shelf support member is a ten-foot-long metal shelf support rail, the power bus runs through the entire ten-foot length of the rail.

A nonconducting insulation provides a buffer between the power bus and a housing of the shelf support rail. The nonconducting insulation fills the interior cavity of the shelf support member between the walls of the housing and the power bus. In this manner, the nonconducting insulation buffers the power bus and fills most of the empty spaces remaining with the cavity. The power bus is isolated from the metal frame of the shelf support member by the buffer provided by the insulation. In some examples, the insulation is plastic. However, the insulation is not limited to plastic insulation.

Alternatively, or in addition to the other examples described herein, examples include any combination of the following:

wherein the location data further comprises a height of the shelf above a floor;
a plurality of resistors within the shelf; and a sensor device associated with the accessory device, wherein the sensor device detects a change in voltage across the plurality of resistors, wherein a third controller device of the accessory device generates an estimated position of the accessory device on the shelf using the detected change in voltage;
the location data is stored by the first controller on a data store associated with the shelf;
a first connector connecting a first accessory device to the shelf; and a second connector connecting a second accessory device to the shelf, wherein the first controller of the shelf transmits the location data to the first accessory device via the first connector, and wherein the first controller of the shelf transmits the location data to the second accessory device via the second connector;
an electronic shelf label connected to the shelf, wherein the electronic shelf label obtains item data for items assigned to the shelf using the location data;
a camera connected to the shelf, wherein the camera obtains the location data from the first controller, and wherein the camera self-configures in accordance with a current location of the camera using the location data;
a set of shelf support members having a plurality of notches, the set of shelf support members comprising a first shelf support member and a second shelf support member;
a plurality of resistors connected in series situated within an interior of the first shelf support member, where a voltage changes as it flows through the plurality of resistors;
a shelf removably attached to the set of shelf support members by a set of support arms, a first support arm in the set of support arms comprising a mounting bracket configured to removably couple to a shelf support notch in the plurality of notches;
a connector coupled to the mounting bracket of the support arm, the connector configured to engage a contact surface associated with the shelf support notch, wherein a sensor associated with the shelf detects a change in voltage across the plurality of resistors when the mounting bracket of the support arm engages the contact surface;
a controller device of the shelf comprising a processor and a memory, wherein the controller device generates location data based on the detected change in the voltage across the plurality of the resistors, wherein the location data comprises an estimated height of the shelf, wherein an accessory device connected to the shelf self-configures in part using the location data;
a serial data port associated with the shelf support notch, wherein the first controller device receives second location data from a second controller device of the shelf support member, wherein the second location data further comprises a UID of the shelf support member and a notch ID associated with the shelf support notch;
a drop-down electrical cord providing electrical power to a converter box, wherein the drop-down electrical cord descends from a location above the set of shelves, and wherein the converter box provides electrical power to the second controller associated with the first shelf support member;
a data storage device associated with the shelf, wherein the first controller associated with the shelf stores the location data on the data storage device;
a first connector connecting a first accessory device to the shelf; and a second connector connecting a second accessory device to the shelf, wherein the first controller of the shelf transmits the location data to the first accessory device via the first connector, and wherein the first controller of the shelf transmits the location data to the second accessory device via the second connector;
a second plurality of resistors within the shelf, wherein a sensor device associated with the accessory device detects a change in voltage across the second plurality of resistors, wherein a third controller device of the accessory device generates an estimated position of the accessory device along a front edge of the shelf using the detected change in voltage;
a camera connected to the shelf, wherein the camera obtains the location data from the first controller, and wherein the camera self-configures in accordance with a current location of the camera using the location data;
obtaining, by a first controller of a shelf, location data identifying a location of a shelf in a set of shelves on a modular display, the location data transmitted to the first controller by a second controller of a vertical shelf support member via a serial data port in a plurality of serial data ports within the vertical shelf support member;
storing the location data on a memory device associated with the first controller of the shelf, the location data comprising a UID associated with a vertical shelf support member and a notch ID associated with a shelf support notch within a plurality of shelf support notches on the shelf support member;
detecting an accessory device connected to the shelf;
providing the location data to the accessory device connected to the shelf, wherein the accessory device self-configures at least in part using the location data;
providing electrical power to a converter box via a drop-down electrical cord connected to an external power supply, wherein the drop-down electrical cord descends from a location above the set of shelves;
connecting a plug associated with the accessory device to a data connection point associated with the shelf, wherein the location data is transmitted to the accessory device via the data connection point;
detecting a change in voltage across a plurality of resistors connected in serial within the vertical shelf support member, wherein the controller device of the shelf generates an estimated height of the shelf above ground using the detected change in voltage;
detecting a change in voltage across a plurality of resistors connected in serial within the shelf, wherein a sensor device associated with the accessory device detects a change in voltage flowing through the plurality of resistors, wherein a controller device of the accessory device generates an estimated position of the accessory device on the shelf using the detected change in voltage;
detecting a shelf plug engaging a notch in the plurality of notches associated with the vertical shelf support member;
transmitting location data to a controller device on the shelf via a serial data port associated with the notch, wherein the location data indicates a current location of the shelf within a retail environment;
detecting a first change in voltage across a first resistor in the plurality of resistors, the first change in voltage associated with a first notch in the plurality of notches, wherein the first notch is associated with a first notch identifier;
detecting a second change in voltage across a second resistor in the plurality of resistors, the second change in voltage associated with a second notch in the plurality of notches, wherein the second notch is associated with a second notch identifier; and detecting a third change in voltage across a third resistor in the plurality of resistors, the third change in voltage associated with a third notch in the plurality of notches, wherein the third notch is associated with a third notch identifier.

At least a portion of the functionality of the various elements in FIG. 1, FIG. 2, FIG. 3, FIG. 4, FIG. 5, FIG. 6, FIG. 7, FIG. 8, FIG. 9, FIG. 10, FIG. 11, and FIG. 12 can be performed by other elements in FIG. 1, FIG. 2, FIG. 3, FIG. 4, FIG. 5, FIG. 6, FIG. 7, FIG. 8, FIG. 9, FIG. 10, FIG. 11 and FIG. 12, or an entity (e.g., processor, application program, controller device, etc.) not shown in FIG. 1, FIG. 2, FIG. 3, FIG. 4, FIG. 5, FIG. 6, FIG. 7, FIG. 8, FIG. 9, FIG. 10, FIG. 11 and FIG. 12.

In some examples, the operations illustrated in FIG. 13 and FIG. 14 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of detecting location of a shelf, the method comprising detecting a change in voltage across a plurality of resistors connected in series within a vertical shelf support member by a controller on a shelf removably attached to a notch within a plurality of notches on the vertical shelf support member; generating an estimated height of the shelf above the ground based on the detected change in voltage; storing the estimated height as location data on a data store of the shelf; and transmitting the location data including the estimated height to an accessory device located on the shelf. The data store includes a memory device or a separate data storage device of the shelf.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The examples illustrated and described herein as well as examples not specifically described herein but within the scope of aspects of the disclosure constitute exemplary means for detecting a location of a shelf. For example, the elements illustrated in FIG. 1, FIG. 2, FIG. 3, FIG. 4, FIG. 5, FIG. 6, FIG. 7, FIG. 8, FIG. 9, FIG. 10, FIG. 11, and FIG. 12, such as when encoded to perform the operations illustrated in FIG. 13 and FIG. 14, constitute exemplary means for obtaining, by a first controller of a shelf, location data identifying a location of a shelf in a set of shelves on a modular display, the location data transmitted to the first controller by a second controller of a vertical shelf support member via a serial data port in a plurality of serial data ports within the vertical shelf support member; exemplary means for storing the location data on a memory device associated with the first controller of the shelf, the location data comprising a UID associated with a vertical shelf support member and a notch ID associated with a shelf support notch within a plurality of shelf support notches on the shelf support member; exemplary means for detecting an accessory device connected to the shelf; and exemplary means for providing the location data to the accessory device connected to the shelf, wherein the accessory device self-configures at least in part using the location data.

Other non-limiting examples provide one or more computer storage devices having a first computer-executable instructions stored thereon for providing shelf height detection. When executed by a computer, the computer performs operations including detecting a change in voltage through a plurality of resistors connected in series; calculating an estimated height of a shelf above a surface; generate location data including the estimated height; storing the location data on a data store (memory or data storage device) accessible to a controller of the shelf; and transmitting the location data to any accessory device connected to the shelf.

Other examples provide a shelf location detection system including a first shelf support member having a plurality of notches, the first shelf support member positioned substantially parallel to a second shelf support member; a plurality of resistors in a stack situated within an interior of the first shelf support member, each resistor within the plurality of resistors in the stack associated with a shelf support notch in the plurality of notches; a shelf removably attached to the first shelf support member via a shelf support arm comprising a mounting bracket at one end of a support arm, wherein the mounting bracket removably couples to the shelf support notch; a plug coupled to the mounting bracket of the support arm, the plug configured to detect a voltage change as a current moves from a first resistor in the plurality of resistors through a second resistor in the plurality of resistors associated with the shelf support notch; and a first controller device associated with the shelf, wherein the first controller device generates location data identifying a location of the shelf on the first shelf support member using the detected voltage change, the location data comprising a unique identifier (UID) of the first shelf support member and a notch ID identifying the shelf support notch, wherein an accessory device connected to the shelf utilizes the location data to automatically perform a self-configuration.

Other non-limiting examples provide one or more computer storage devices having a first computer-executable instructions stored thereon for providing location detection. When executed by a computer, the computer performs operations including detecting a change in voltage across a plurality of resistors connected in series within a portion of a shelf by a sensor device of an accessory device associated with the shelf; identify a position of the accessory device on the shelf based on the change in voltage; store the identified position of the accessory device as location data on the accessory device, wherein the accessory device self-configures using the location data.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A shelf location detection system comprising:
a first shelf support member having a plurality of notches, the first shelf support member positioned substantially parallel to a second shelf support member;
a plurality of resistors in a stack situated within an interior of the first shelf support member, each resistor within the plurality of resistors in the stack associated with a shelf support notch in the plurality of notches;
a shelf removably attached to the first shelf support member via a shelf support arm comprising a mounting bracket at one end of a support arm, wherein the mounting bracket removably couples to the shelf support notch;
a plug coupled to the mounting bracket of the support arm, the plug configured to detect a voltage change as a current moves from a first resistor in the plurality of resistors through a second resistor in the plurality of resistors associated with the shelf support notch; and
a first controller device associated with the shelf, wherein the first controller device generates location data identifying a location of the shelf on the first shelf support member using the detected voltage change, the location data comprising a unique identifier (UID) of the first shelf support member and a notch ID identifying the shelf support notch, wherein an accessory device connected to the shelf utilizes the location data to automatically perform a self-configuration.

2. The shelf location detection system of claim 1, wherein the location data further comprises a height of the shelf above a floor.

3. The shelf location detection system of claim 1, further comprising:
a second plurality of resistors within the shelf; and
a sensor device associated with the accessory device, wherein the sensor device detects a change in voltage across at least one resistor in the second plurality of resistors as the voltage moves through the second plurality of resistors, wherein a second controller device of the accessory device generates an estimated position of the accessory device on the shelf using the detected change in the voltage.

4. The shelf location detection system of claim 1, wherein the location data is stored by the first controller device on a data store associated with the shelf.

5. The shelf location detection system of claim 1, further comprising:
a first connector connecting a first accessory device to the shelf; and
a second connector connecting a second accessory device to the shelf, wherein the first controller device of the shelf transmits the location data to the first accessory device via the first connector, and wherein the first controller device of the shelf transmits the location data to the second accessory device via the second connector.

6. The shelf location detection system of claim 1, further comprising:
an electronic shelf label connected to the shelf, wherein the electronic shelf label receives item data for items assigned to the shelf using the location data.

7. The shelf location detection system of claim 1, further comprising:
a camera connected to the shelf, wherein the camera receives the location data from the first controller device, and wherein the camera self-configures in accordance with a current location of the camera using the location data.

8. A shelf location detection system comprising:
a smart shelf support member having a plurality of notches;
a plurality of resistors connected in series situated within an interior of the smart shelf support member, where a voltage moving through the plurality of resistors decreases as the voltage flows through each resistor in the plurality of resistors;
a shelf removably attached to the smart shelf support member by a set of support arms, a support arm in the set of support arms comprising a mounting bracket configured to removably couple to a shelf support notch in the plurality of notches;
a connector coupled to the mounting bracket of the support arm, the connector configured to engage a contact surface associated with the shelf support notch, wherein a sensor associated with the shelf detects a change in the voltage across a resistor in the plurality of resistors associated with the shelf support notch when the mounting bracket of the support arm engages the contact surface; and
a controller device of the shelf comprising a processor and a memory, wherein the controller device generates location data based on the detected change in the voltage, wherein the location data comprises an estimated height of the shelf, wherein an accessory device connected to the shelf self-configures in part using the location data.

9. The shelf location detection system of claim 8, wherein the shelf is a smart shelf, and wherein the controller device of the smart shelf is a first controller device, and further comprising:
a second plurality of resistors within the smart shelf; and
a sensor device associated with the accessory device, wherein the sensor device detects a change in voltage across at least one resistor in the second plurality of resistors as the voltage moves through the second plurality of resistors, wherein a second controller device of the accessory device generates an estimated position of the accessory device on the smart shelf using the detected change in the voltage.

10. The shelf location detection system of claim 8, wherein the controller device of the shelf is a first controller device, and further comprising:
a drop-down electrical cord providing electrical power to a converter box, wherein the drop-down electrical cord descends from a location above a set of shelves, and wherein the converter box provides the electrical power to a second controller device associated with the smart shelf support member.

11. The shelf location detection system of claim 8, further comprising:
a data storage device associated with the shelf, wherein the controller device of the shelf stores the location data on the data storage device.

12. The shelf location detection system of claim 8, further comprising:
a first connector connecting a first accessory device to the shelf; and
a second connector connecting a second accessory device to the shelf, wherein the controller device of the shelf transmits the location data to the first accessory device via the first connector, and wherein the controller device of the shelf transmits the location data to the second accessory device via the second connector.

13. The shelf location detection system of claim 8, further comprising:
a first sensor associated with a first shelf removably attached to the smart shelf support member at a first notch, wherein the first sensor detects a first change in voltage across a first resistor in the plurality of resistors, the first change in voltage associated with the first notch in the plurality of notches; and
a second sensor associated with a second shelf removably attached to the smart shelf support member at a second notch in the plurality of notches, wherein the second sensor detects a second change in voltage across a second resistor in the plurality of resistors, the second change in voltage associated with the second notch in the plurality of notches, wherein the second change in voltage is a different change in voltage than the first change in voltage.

14. The shelf location detection system of claim 8, further comprising:
a camera connected to the shelf, wherein the camera receives the location data from the controller device of the shelf, and wherein the camera self-configures in accordance with a current location of the camera using the location data.

15. A method for detecting a location of a shelf, the method comprising:
detecting a change in voltage across a resistor in a plurality of resistors within a smart shelf support member by a sensor device of a smart shelf;
generating location data identifying a location of the smart shelf on the smart shelf support member using the change in voltage across the resistor, the location data identifying the location of the shelf in a set of shelves on a modular display;
storing the location data on a memory device associated with a first controller of the shelf, the location data comprising a UID associated with the smart shelf support member and a notch ID associated with a shelf support notch within a plurality of notches on the smart shelf support member;
detecting an accessory device connected to the shelf; and
providing the location data to the accessory device connected to the shelf, wherein the accessory device self-configures at least in part using the location data.

16. The method of claim 15, further comprising:
providing electrical power to a converter box via a drop-down electrical cord connected to an external power supply, wherein the drop-down electrical cord descends from a location above the set of shelves.

17. The method of claim 15, further comprising:
connecting a plug associated with the accessory device to a data connection point associated with the shelf, wherein the location data is transmitted to the accessory device via the data connection point.

18. The method of claim 15, further comprising:
detecting a first change in voltage across a first resistor in the plurality of resistors, the first change in voltage associated with a first notch in the plurality of notches;
detecting a second change in voltage across a second resistor in the plurality of resistors, the second change in voltage associated with a second notch in the plurality of notches; and
detecting a third change in voltage across a third resistor in the plurality of resistors, the third change in voltage associated with a third notch in the plurality of notches.

19. The method of claim 15, further comprising:
detecting a change in voltage across a second plurality of resistors connected in series within the shelf, wherein a sensor device associated with the accessory device detects the change in the voltage flowing through the plurality of resistors, wherein a controller device of the accessory device generates an estimated position of the accessory device on the shelf using the change in the voltage.

20. The method of claim 15, further comprising:
detecting a shelf plug engaging the shelf support notch in the plurality of notches associated with the smart shelf support member; and
transmitting the location data to a second controller device associated with a first accessory device on the shelf via a first connector connecting the first accessory device to the shelf; and
transmitting the location data to a third controller device associated with a second accessory device on the shelf via a second connector connecting the second accessory device to the shelf, wherein the location data identifies a location of the shelf on the smart shelf support member.
